(19) United States
(12) Patent Application Publication
(10) Pub. No.: US 2012/0306874 A1
(43) Pub. Date: Dec. 6, 2012

(54) METHOD AND SYSTEM FOR SINGLE VIEW IMAGE 3 D FACE SYNTHESIS

(75) Inventors: Hong Thai Nguyen, Singapore (SG); Ee Ping Ong, Singapore (SG); Arthur Niswar, Singapore (SG); Zhiyong Huang, Singapore (SG); Susanto Rahardja, Singapore (SG)

(73) Assignee: AGENCY FOR SCIENCE, TECHNOLOGY AND RESEARCH, Singapore (SG)

(21) Appl. No.: 13/515,578

(22) PCT Filed: Dec. 14, 2010
(86) PCT No.: PCT/SG10/00465

§ 371 Date: Aug. 22, 2012

(30) Foreign Application Priority Data
Dec. 14, 2009 (SG) 200908315-5

(51) Int. Cl. G06T 17/00

(52) U.S. Cl. 345/420

(57) ABSTRACT

A method and system for of single view image 3D face synthesis. The method comprises the steps of a) extracting feature points from the single view image; b) transforming the feature points into 3D space; c) calculating radial basis function (RBF) parameters in 3D space based on the transformed feature points and corresponding points from a 3D generic model; d) applying RBF deformation to the generic 3D model based on the RBF parameters to determine a model for the synthesized 3D face; and e) determining texture coordinates for the synthesized 3D face in 2D image space; wherein step b) comprises symmetrically aligning the feature points, and step e) comprises projecting the generic 3D model or the model for the synthesized 3D face into 2D image space and applying RBF deformation to the projected generic 3D model or the projected model for the synthesized 3D face.

### FIELD OF INVENTION

The present invention relates broadly to a method and system of single view image 3D face synthesis.

### BACKGROUND

Automatic generation of realistic 3D human faces is a challenging task in the field of computer vision and computer graphics. It is recognised that various applications such as avatar creation for human computer interaction, virtual reality, computer games, video conferencing, immersive telecommunications, and 3D face animation can benefit from photo-realistic human face models.

For techniques using a single view image for 3D face synthesis, unsupervised 3D face reconstruction can be achieved without any off-line operations. This can facilitate real-time applications like video phony and video conferencing. However, currently, some single view-based algorithms are only capable of coping with front-view inputs while some algorithms require significant user interaction and manual work to mark out facial features.

For example, in Kuo et. al. [2002, 3-D Facial Model Estimation from Single Front-View Facial Image, In IEEE Trans. on Cir. and Syst. For Video Tech., vol. 12, no. 3] a method is proposed which can automatically detect only four feature points at eye corners and eye centres. These feature points are called reference points. The positions of all other feature points are derived from anthropometric relationships between the references points and these other feature points. A 3D-mesh model can be constructed directly from the obtained feature point set.

In a similar study, Zhang et. al. [2004, Video-based fast 3d individual facial modeling, In Proceeding of the 14^{th} International Conference on Artificial Reality and Telexistence, pages 269-272] used the RealBoost-Gabor ASM algorithm taught in Huang et. al. [2004, Shape localization by statistical learning in the Gabor feature space. In ICSP, pages 167-176] to automatically detect feature points. The radial-basis function (RBF) deformation method is used to deform a generic model according to the detected feature points. Both Kuo et al. and Zhang et. al. used planar projection to project texture image onto the generated models.

One significant problem with the above existing techniques is that a frontal face image is typically required. It has been recognised that without imposing strict and rigid restrictions on how a person is going to position his/her face in order to capture the face image, it is substantially difficult to capture a purely frontal image of the face from e.g. a normal webcam. That is, while a frontal image can be captured, it is typical that the frontal image exhibits a face that is slightly turned to the left or right and/or upwards or downwards. The eye shape contour also typically varies depending on where the subject looks. Thus, the feature point set obtained for face synthesis is typically asymmetric. In such cases, using the extracted feature points together with RBF deformation and planar projection of texture mapping cannot produce satisfactory results.

Therefore, there exists a need for a method and system of 3D image generation that seek to address at least one of the above problems.

### SUMMARY

According to a first aspect of the present invention, there is provided a method of single view image 3D face synthesis comprising the steps of a) extracting feature points from the single view image; b) transforming the feature points into 3D space; c) calculating radial basis function (RBF) parameters in 3D space based on the transformed feature points and corresponding points from a 3D generic model; d) applying RBF deformation to the generic 3D model based on the RBF parameters to determine a model for the synthesized 3D face; and e) determining texture coordinates for the synthesized 3D face in 2D image space; wherein step b) comprises symmetrically aligning the feature points, and step e) comprises projecting the generic 3D model or the model for the synthesized 3D face into 2D image space and applying RBF deformation to the projected generic 3D model or the projected model for the synthesized 3D face.

Step e) may comprise calculating RBF parameters in 2D image space based on the feature points and corresponding points in the generic 3D model projected into 2D image space, and applying RBF deformation to the projected generic 3D model.

Step e) may comprise calculating RBF parameters in 2D image space based on the feature points and corresponding points in the model for the synthesized 3D face projected into 2D image space, and applying RBF deformation to the projected model for the synthesized 3D face.

Step a) may comprise applying a face detection algorithm to detect a face region in the single view image.

The method may further comprise using an active shape model to extract the feature points from the detected face region.

According to a second aspect of the present invention, there is provided a system for single view image 3D face synthesis comprising means for extracting feature points from the single view image; means for transforming the feature points into 3D space; means for calculating radial basis function (RBF) parameters in 3D space based on the transformed feature points and corresponding points from a 3D generic model; means for applying RBF deformation to the generic 3D model based on the RBF parameters to determine a model for the synthesized 3D face; and means for determining texture coordinates for the synthesized 3D face in 2D image space; wherein the means for transforming the feature points symmetrically aligns the feature points, and the means for determining the texture coordinates projects the generic 3D model or the model for the synthesized 3D face into 2D image space and applies RBF deformation to the projected generic 3D model or the projected model for the synthesized 3D face.

According to a third aspect of the present invention, there is provided a data storage medium having computer code means for instructing a computer to execute a method of single view image 3D face synthesis comprising the steps of a) extracting feature points from the single view image; b) transforming the feature points into 3D space; c) calculating radial basis function (RBF) parameters in 3D space based on the transformed feature points and corresponding points from a 3D generic model; d), applying RBF deformation to the generic 3D model based on the RBF parameters to determine a model for the synthesized 3D face; and e) determining texture coordinates for the synthesized 3D face in 2D image space; wherein step b) comprises symmetrically aligning the feature points, and step e) comprises projecting the generic 3D Model or the model for the synthesized 3D face into 2D image space and applying RBF deformation to the projected generic 3D model or the projected model for the synthesized 3D face.

According to a fourth aspect of the present invention, there is provided a method of single view image 3D face synthesis comprising the steps of a) extracting feature points from the single view image; b) transforming the feature points into 3D space; c) calculating radial basis function (RBF) parameters in 3D space based on the transformed feature points and corresponding points from a 3D generic model; d) applying RBF deformation to the generic 3D model based on the RBF parameters to determine a model for the synthesized 3D face; and e) determining texture coordinates for the synthesized 3D face in 2 D image space; wherein step b) comprises symmetrically aligning the feature points.

According to a fifth aspect of the present invention, there is provided a method of single view image 3D face synthesis comprising the steps of a) extracting feature points from the single view image; b) transforming the feature points into 3D space; c) calculating radial basis function (RBF) parameters in 3D space based on the transformed feature points and corresponding points from a 3D generic model; d) applying RBF deformation to the generic 3D model based on the RBF parameters to determine a model for the synthesized 3D face; and e) determining texture coordinates for the synthesized 3D face in 2D image space; wherein step e) comprises projecting the generic 3D model or the model for the synthesized 3D face into 2D image space and applying RBF deformation to the projected generic 3D model or the projected model for the synthesized 3D face.

According to a sixth aspect of the present invention, there is provided a system for single view image 3D face synthesis comprising means for extracting feature points from the single view image; means for transforming the feature points into 3D space; means for calculating radial basis function (RBF) parameters in 3D space based on the transformed feature points and corresponding points from a 3D generic model; means for applying RBF deformation to the generic 3D model based on the RBF parameters to determine a model for the synthesized 3D face; and means for determining texture coordinates for the synthesized 3D face in 2D image space; wherein the means for transforming the feature points symmetrically aligns the feature points.

According to a seventh aspect of the present invention, there is provided a system for single view image 3D face synthesis comprising means for extracting feature points from the single view image; means for transforming the feature points into 3D space; means for calculating radial basis function (RBF) parameters in 3D space based on the transformed feature points and corresponding points from a 3D generic model; means for applying RBF deformation to the generic 3D model based on the RBF parameters to determine a model for the synthesized 3D face; and means for determining texture coordinates for the synthesized 3D face in 2D image space; wherein the means for determining the texture coordinates projects the generic 3D model or the model for the synthesized 3D face into 2D image space and applies RBF deformation to the projected generic 3D model or the projected model for the synthesized 3D face.

According to an eighth aspect of the present invention, there is provided a data storage medium having computer code means for instructing a computer to execute a method of single view image 3D face synthesis comprising the steps of a) extracting feature points from the single view image; b) transforming the feature points into 3D space; c) calculating radial basis function (RBF) parameters in 3D space based on the transformed feature points and corresponding points from a 3D generic model; d) applying RBF deformation to the generic 3D model based on the RBF parameters to determine a model for the synthesized 3D face; and e) determining texture coordinates for the synthesized 3D face in 2D image space; wherein step b) comprises symmetrically aligning the feature points.

According to a ninth aspect of the present invention, there is provided a data storage medium having computer code means for instructing a computer to execute a method of single view image 3D face synthesis comprising the steps of a) extracting feature points from the single view image; b) transforming the feature points into 3D space; c) calculating radial basis function (RBF) parameters in 3D space based on the transformed feature points and corresponding points from a 3D generic model; d) applying RBF deformation to the generic 3D model based on the RBF parameters to determine a model for the synthesized 3D face; and e) determining texture coordinates for the synthesized 3D face in 2D image space; wherein step e) comprises projecting the generic 3D model or the model for the synthesized 3D face into 2D image space and applying RBF deformation to the projected generic 3D model or the projected model for the synthesized 3D face.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 is a schematic flowchart for illustrating a method of 3D face generation in an example embodiment.

FIG. 2 shows the results of the face contours according to an example embodiment.

FIG. 3a) shows a single view input image

FIGS. 3 b) and c) show display of the synthesized 3D face from the input image of FIG. 1a) using prior art techniques.

FIG. 3d) shows the synthesized 3D face from the input image of FIG. 3a) according to an example embodiment. FIGS. 3e) and 3f) show the snapshots of the reconstructed 3D face at different angles according to the example embodiment.

FIG. 4 is a schematic illustration of a computer system for implementing a method and system of 3D face generation in an example embodiment.

### DETAILED DESCRIPTION

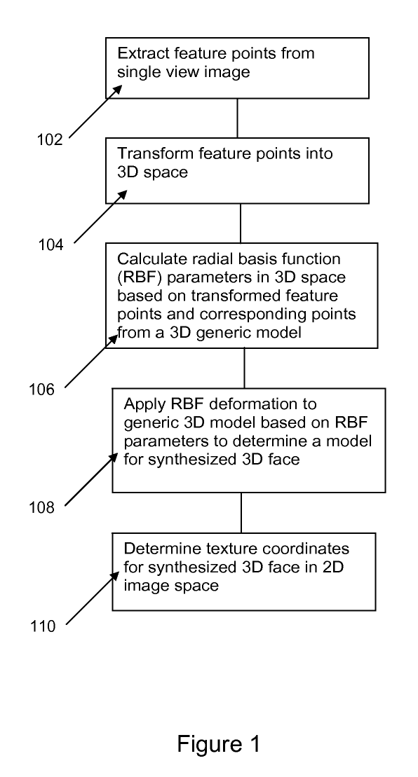

FIG. 1 shows a flowchart 100 illustrating a method of 3D face synthesis from a single view image according to example embodiments. At step 102, feature points are extracted from the single view image. At step 104, the feature points are transformed into 3D space. At step 106, radial basis function (RBF) parameters in 3D space are calculated based on the transformed feature points and corresponding points from a 3D generic model. At step 108, RBF deformation is applied to the generic 3D model based on the RBF parameters to determine a model for the synthesized 3D face. At step 110, texture coordinates for the synthesized 3D face in 2D space are determined.

In embodiments of the present invention, step 104 comprises symmetrically aligning the feature points and/or step 110 comprises projecting the generic 3D model or the model for the synthesized 3D face into 2D image space and applying RBF deformation to the projected generic 3D model or the projected model for the synthesized 3D face.

Example embodiments described below can provide a system for automatic and real-time 3D photo-realistic face synthesis from a single frontal face image. The system can employ a generic 3D head model approach for 3D face synthesis which can generate the 3D mapped face in real-time. The system may first automatically detect face features from an input face image that corresponds to landmark points on a generic 3D head model. Thereafter, the generic head model can be deformed to match the detected features. The texture from the input face image can then be mapped onto the deformed 3D head model to create a photo-realistic 3D face. The system can have the advantage of being totally automatic and in real-time. Good results can be obtained with no user intervention. Such a system may be useful in many applications such as the creation of avatars for virtual worlds by end-users with no need for manual and tedious processes such as manual feature placements on the face images.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

The invention may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

In the following, details of steps 102 to 110 in FIG. 1 will be described for one example embodiment.

In order to extract the face's feature points in step 102, the system first detects the face region from the input image. This face region can be detected by any face detector. In one embodiment, a Rowley face detector [Rowley et al. 1998] for detecting the face from the input image is used.

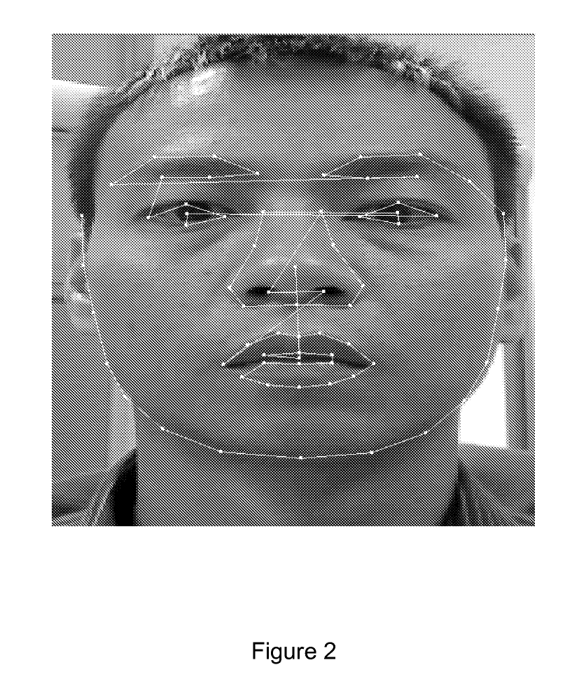

To extract the feature points from the detected face region, the extended active shape model (ASM) method presented by Milborrow and Nicolls [2008] is used in this example embodiment ASM was firstly presented by Cootes et al. [1992]. The underlying principle is that from the set of examples of a shape, a statistical shape model is being built. Each shape in the training set is represented by a set of n labeled landmark points, which must be consistent from one shape to the next. By varying the shape model parameters within limits learnt from the training set, the new shape can be generated. Based on this model, the Active Shape Model iteratively deforms the shape of the object to fit the object in example images. The results of the face contours are shown in FIG. 2.

In general terms, the task of model fitting is to adapt a generic 3D head mesh to fit the set of face feature points. In this example embodiment, a 3D modeling software is used to create a high-resolution 3D head mesh and then landmark points are annotated on the mesh to correspond to the positions which will correlate to the feature points extracted from the input face image. In other words, given the input face image, the extracted set of feature points are those that are supposed to correspond to the landmark points on the 3D head mesh.

A scattered data interpolation process uses the set of feature points and landmark points to compute the position of the mesh vertices, as will be explained in more detailed below. The same process is applied for vertex positions in texture space, again as will be described in more detailed below. Because in this example embodiment there is no depth information of feature points from the single face image, the depth values are omitted. The target is to have the face contour, eye, mouth and nose contour to look similar to those in face image.

To transform the feature points from image space to 3D model space (compare step 102 in FIG. 1), two coordinate systems in image space and model space respectively are established, I and S. For both systems, the origins are middle points between the eye corners. The X direction is the vector from right eye corner to left eye corner. The Z direction in the image space points outwards perpendicular to the image (In 3D space it is the direction perpendicular to the face). The Y direction is the cross product of Z and X. The unit length in image space and model space is half the distance between the eye corners. Thus, in order to transform a feature point into the model space from a feature point in the image space, the coordination of that feature point in the established coordination system 1 is computed.

Let Iₖ(x,y) and Sₖ(x,y,z) be respective sets of detected feature point in the image and set of landmark points in model space.

Let Oⁱ, O^{s} be the middle points of two feature/landmark points at left eye and right eye corners in the image space and the model space respectively, where

Oⁱ=0.5(I_{ieye}(x,y)+I_{reye}(x,y))

O^{s}=0.5(S_{ieye}(x,y,z)+S_{reye}(x,y,z))

The X direction of the respective coordinate systems are:

\vec{eₓⁱ}=normalized(I_{reye}−Oⁱ)=(I′_{reye}−Oⁱ)/|I_{reye}−Oⁱ|

\vec{eₓ^{s}}=normalized(S_{reye}−O^{s})=(S_{reye}−O^{s})/|S_{reye}−O^{s}|

The Y direttions of the respective coordination Systems are the X directions rotated by 90 degrees clockwise, such that

e_{y}ⁱx=eₓⁱy, e_{y}ⁱy=−eₓⁱx

e_{y}^{s}x=eₓ^{s}y, e_{y}^{s}y=−eₓ^{s}x

The Y directions of the respective coordination systems are the cross products of the Y and X directions, such that

\vec{e}_{z}ⁱ=\vec{e}_{y}ⁱ×\vec{e}ₓⁱ

\vec{e}_{z}^{s}=\vec{e}_{z}^{s}×\vec{e}ₓ^{s}

Let l′=|I_{reye}−Oⁱ|, l^{s}=|I_{reye}−O^{s}|

Let (Oⁱ,\vec{eₓⁱ}, \vec{e_{y}ⁱ}, \vec{e_{z}ⁱ},lⁱ), (O^{s}, \vec{eₓ^{s}},\vec{e_{z}^{s}},l^{s}) define the respective coordinate systems in the image and the model space.

The normalized Īₖ(x,y) is calculated as:

Īₖx=(Iₖ(x,y)−Oⁱ)·\vec{eₓⁱ}/lⁱ

Īₖy=(Iₖ(x,y)−Oⁱ)·\vec{e_{y}ⁱ}/lⁱ

Next, Īₖ(x,y) are symmetrized to symmetrically align the feature points in the image space.

I*ₖₗx=Īₖₗx−0.5(Īₖₗx+Īₖᵣx)

I*ₖᵣx=Īₖᵣx−0.5(Īₖₗx+Īₖᵣx)

I*ₖₗy=Īₖᵣy−0.5(Īₖₗy+Īₖᵣy)

Next, the I*ₖ(x,y) are transformed to the model space Sₖ^{T}(x,y,z) as

Sₖ^{T}x=I*ₖx

Sₖ^{T}y=I*ₖy

Sₖ^{T}z=0

The Sₖ^{T}(x,y,z) are further transformed in the 3D model space as follows:

Sₖ′(x,y)=Oₛ+l^{s}|\vec{eₓ^{s}}\vec{e_{y}^{s}}|S^{T}(x,y)

We set Sₖ′z=0 also.

The Sₖ′(x,y,z) (i.e. transformed from Iₖ (x,y)) and the Sₖ(x,y,z) are then used as sets of target and source points to enter Radial Basic Function (RBF) deformations. To make the deformation more precise they are aligned one more time by subtracting the value of center mass (subscript ‘cm’) from their values, such that

$${S}_{cm} = \frac{\sum {S}_{k}}{\vert S \vert} {S}_{cm}^{′} = \frac{\sum {S}_{k}^{′}}{\vert {S}^{′} \vert}$$

$${\overline{S}}_{k}^{′} = {S}_{k}^{′} - {S}_{cm}^{′} , {\overline{S}}_{k} = {S}_{k} - {S}_{cm}$$

In general terms, the task of scattered data interpolation is to find a smooth vector value f(p) fitted to the known data uᵢ=f(pᵢ), from which we can compute uⱼ=f(pⱼ).

The family of RBFs is understood in the art to have powerful interpolation capability. For example, RBF is used in [Pighin et al. 1998] and [Noh and Neumann 2001] for face model fitting. RBF has a function of the form:

$$f ( p ) = {\sum }_{i} {w}_{i} {h}_{i} ( ‖ p - {p}_{i} ‖ )$$

where h(r) is a radially symmetric basis function. This RBF form is used by Zhang et al. [2004], [2005]. In this example embodiments, a more general form of this interpolant is used. The more general form adds some low-order polynomial terms to model global affine deformation. Similar to [Pighin 1998] and [Cohen-or et al. 1998], an affine basis is used as part of the interpolation algorithm and thus the RBF in this example embodiment has a function of the form:

$$f ( p ) = {\sum }_{i} {w}_{i} h ( ‖ p - {p}_{i} ‖ ) + Mp + t$$

To determine the coefficients wᵢ and affine components M and t (compare step 106 in FIG. 1), a set of linear equations is solved that include the interpolation contraints uᵢ=f(pᵢ) as well as the constraints

$${\sum }_{i} {w}_{i} = 0 and {\sum }_{i} {w}_{i} {p}_{i}^{T} = 0 ,$$

which remove affine contributions from the radial basis functions. For h(r), this embodiment chooses h(r)=e^{-r/K}. The constant K has value range from 10-100, over which range no noticeable difference was observed in different example embodiments.

By Definition of the RBF,

S̅ₖ′=RBF( S̅ₖ)

So every point P of the generic model in the model space will be deformed to point P′ (compare step 108 in FIG. 1) by equation

P′=RBF(P−S_{cm})+S_{cm}′

For texture mapping, since all ASM methods detect the face contour and feature points which best fit the statistical model, the inventors have recognised that the extracted face contour and feature points will not lay exactly at the real image contours. As such, the use of planar projection for texture mapping leads to errors. In the example embodiment, RBF with affine transformation is used instead to generate texture coordinates.

First the values of the image detected feature points are normalized to [0,1] range as follow:

$${I}_{k}^{″} ( x , y ) = \frac{{I}_{k} ( x , y ) - min ( {I}_{k} ( x , y ) ) + {C}^{i} ( x , y )}{max ( {I}_{k} ( x , y ) ) - min ( {I}_{k} ( x , y ) ) + 2 {C}^{i} ( x , y )}$$

Cⁱ(x,y) are specific constants.

$${C}_{x}^{i} = \frac{1}{12} ( max {I}_{k} x - min {I}_{k} x ) , {C}_{y}^{i} = 0.4 ( max {I}_{k} y - min {I}_{k} y )$$

On the other hand, the landmark point in 3D space, after deformation became S̅ₖ′, as described above.

The (deformed) landmark points and the points of the new model for the synthesized 3D face are projected by planar projection to texture space and normalized to a [0,1] range, such that

$${I}_{k}^{m} ( x , y , z ) = \frac{{\overline{S}}_{k}^{′} ( x , y , z ) - {C}_{min}^{s} ( x , y , z )}{{C}_{max}^{s} ( x , y , z ) - {C}_{min}^{s} ( x , y , z )}$$

$${P}^{″} ( x , y , z ) = \frac{{P}^{′} ( x , y , z ) - {C}_{min}^{s} ( x , y , z )}{{C}_{max}^{s} ( x , y , z ) - {C}_{min}^{s} ( x , y , z )}$$

Next, a RBF function is constructed which will map texture coordinates of each vertex to image space, which are used as final texture coordinates.

The Iₖ″(x,y,0) and Iₖ′″(x,y,0) are respective sets of target and source points to enter the RBF deformation. To make the deformation more precise, the respective sets are aligned one more time by subtracting the value of center mass from their values, such that

$${I}_{cm}^{″} = \frac{\sum {I}_{k}^{″}}{\vert {I}_{k}^{″} \vert} , {I}_{cm}^{′′′} = \frac{\sum {I}_{k}^{′′′}}{\vert {I}_{m}^{′′′} \vert}$$

$${\overline{I}}_{k}^{″} = {I}_{k}^{″} - {I}_{cm}^{″} , {\overline{I}}_{k}^{′′′} = {I}_{k}^{′′′} - {I}_{cm}^{′′′}$$

By Definition of the RBF,

Iₖ″=RBF(Īₖ′″)

So every point P′ will have texture coordinate T (u,v,0) by equation

T(u,v,0)=RBF(P″−I_{cm}′″)+I_{cm}″

Using the original image as texture, the final texture coordinate (T′u,T′v) for every point P′ will be

T′u=Tu*(max(Iₖx)−min(Iₖx)+2Cⁱx)/I_{width}+min I(ₖx)/I_{width}

T′v=Tv*(max(Iₖy)−min(Iₖy)+2Cⁱy)/I_{height}+min I(ₖx)/I_{height}

In the above described example embodiment, the RBF with affine transformation to generate texture coordinates is using the new model for the synthesized 3D face and the deformed landmark points [which are equivalent to the extracted feature points from the image as transformed into 3D space]. However, in another example embodiment, the RBF with affine transformation to generate texture coordinates can instead be based on the generic 3D model and the landmark points of the generic model, and otherwise following the same steps as described above for RBF with affine transformation to generate texture coordinates based on the model for the synthesized 3D face and the deformed landmark points.

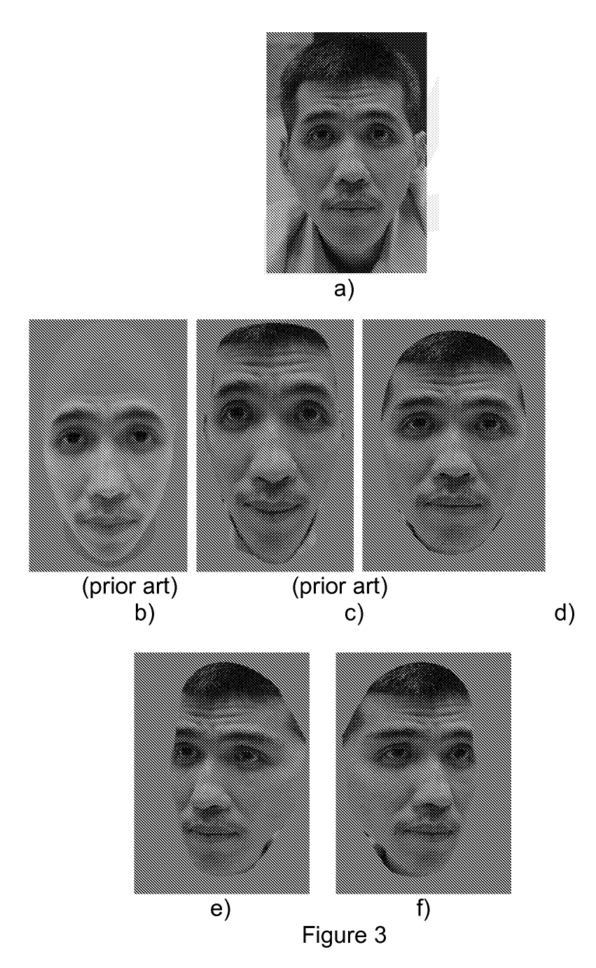

In the described example embodiment an automatic image-based method and system for 3D face synthesis using only a single face image are provided. The example embodiment uses an approach to generate a symmetrically-aligned set of feature points which advantageously helps to obtain better results for the 3D synthesized face and also an approach that employs RBF in texture mapping to advantageously correctly map the model points to the texture space. The embodiment has the advantage of being fully automatic and running in real-time. Experiments conducted show that good results can be obtained with no user intervention, as illustrated in FIG. 3, which shows comparative results. More particular, FIG. 3a) shows a single view input image, FIGS. 3 b) and c) show display of the synthesized 3D face using prior art techniques, whereas FIGS. 3d), 3e) and 3f) show the synthesized 3D face according to an example embodiment, obtained fully automatically in less than 2 seconds on a normal PC.

The automatic 3D face synthesis system and method of the example embodiment can be a building block for a complete system capable of automatic 3D face synthesis and animation there are many ways to enhance and extend the technique in different embodiments, such as: (1) Depth estimation: With depth information, 3D model reconstruction will be easier and also more accurate; (2) Relighting: In the example embodiment, texture is from image acquired at certain lighting configuration. To enable it to be used in other applications or lighting conditions, relighting technique can be developed and incorporated.

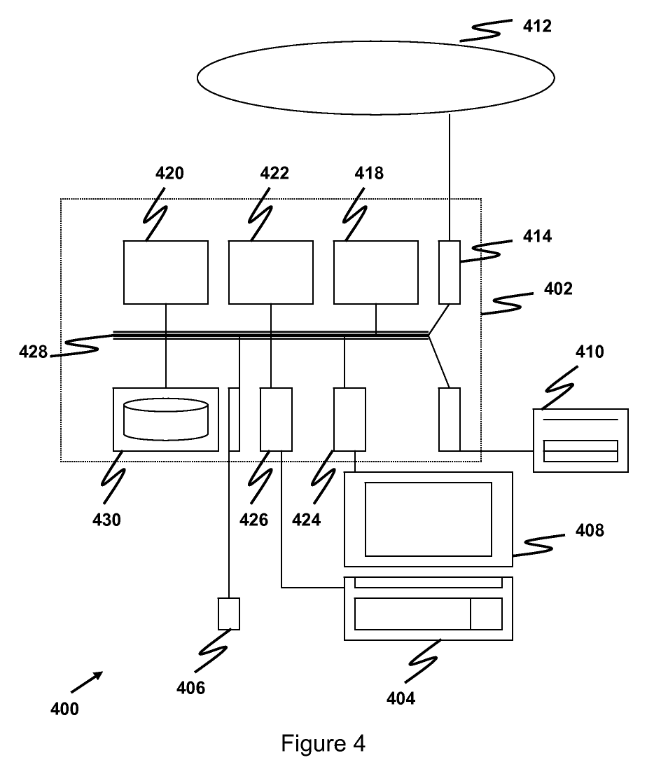

The method and system of the example embodiments can be implemented on a computer system 400, schematically shown in FIG. 4. It may be implemented as softWare, such as a computer: program being executed within the computer system 400, and instructing the computer system 400 to conduct the method of the example embodiments.

The computer system 400 comprises a computer module 402, input modules such as a keyboard 404 and mouse 406 and a plurality of output devices such as a display 408, and printer 410.

The computer module 402 is connected to a computer network 412 via a suitable transceiver device 414, to enable access to e.g. the Internet or other network systems such as Local Area Network (LAN) or Wide Area Network (WAN).

The computer module 402 in the example includes a processor 418, a Random Access Memory (RAM) 420 and a Read Only Memory (ROM) 422. The computer module 402 also includes a number of Input/Output (I/O) interfaces, for example I/O interface 424 to the display 408, and 110 interface 426 to the keyboard 404.

The components of the computer module 402 typically communicate via an interconnected bus 428 and in a manner known to the person skilled in the relevant art.

The application program is typically supplied to the user of the computer system 400 encoded on a data storage medium such as a CD-ROM or flash memory carrier and read utilising a corresponding data storage medium drive of a data storage device 430. The application program is read and controlled in its execution by the processor 418. Intermediate storage of program data maybe accomplished using RAM 420.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

### REFERENCES INCORPORATED BY CROSS-REFERENCE

COHEN-OR, D., LEVIN, D., AND SOLOMOVICI, A. 1998. Three-dimensional Distance Field Metamorphosis. In Proceedings of ACM SIGGRAPH 1998, Computer Graphics Proceedings, Annual Conference Series, pp. 116-141.
COOTES, T.F., TAYLOR, J.C. 1992. Active Shape Models—Smart Snakes. In Proc. British Machine Vision Conference. Springer-Verlag, 1992, pp. 266-275.
KUO, C. J., HUANG, R., LIN, T. 2002. 3-D Facial Model Estimation from Single Front-View Facial Image. In IEEE Trans. on Cir. and Syst. For Video Tech., vol. 12, no. 3.
MILBORROW, S., NICOLLS, F., 2008. Locating Facial Features with an Extended Active Shape Model. In Proceedings of the 10th European Conference on Computer Vision, pp 504-513, Marseille, France.
NOH, J., AND NEUMANN, U. 2001. Expression cloning. In Proceedings of ACM SIGGRAPH 2001, Computer Graphics Proceedings, Annual Conference Series, pp. 403-410.
PIGHIN, F., HECKER, J., LISHINSKI, D., SZELISKI, R., AND SALESIN D. H. 1998. Synthesizing Realistic Facial Expression from Photographs. In Proceeding of ACM SIGGRAPH 98. Computer Graphics Proceeding, pp. 75-84.
ROWLEY, H. A., BALUJA, S., AND KANADE, T. 1998. Neural Network-Based Face Detection. IEEE Transactions on Pattern Analysis and Machine Intelligence, volume 20, number 1, pages 23-38.
ZHANG, M., LU, P., HUANG, X., ZHOU, X., AND WANG, Y. 2004. Video-based fast 3d individual facial modeling. In Proceeding of the 14^{th} International Conference on Artificial Reality and Telexistence, pages 269-272.
ZHANG, M., YAO, J., DING, B., AND WANG, Y. 2005. Fast Individual Face modeling and Animation. In Proceedings of the Second Australasian Conference on interactive Entertainment, Sydney, Australia p 235-239.

1. A method of single view image 3D face synthesis comprising the steps of:
a) extracting feature points from the single view image;
b) transforming the feature points into 3D space;
c) calculating radial basis function (RBF) parameters in 3D space based on the transformed feature points and corresponding points from a 3D generic model;
d) applying RBF deformation to the generic 3D model based on the RBF parameters to determine a model for the synthesized 3D face; and
e) determining texture coordinates for the synthesized 3D face in 2D image space;
wherein step b) comprises symmetrically aligning the feature points, and
step e) comprises projecting the generic 3D model or the model for the synthesized 3D face into 2D image space and applying RBF deformation to the projected generic 3D model or the projected model for the synthesized 3D face.

2. The method as claimed in claim 1, wherein step e) comprises calculating RBF parameters in 2D image space based on the feature points and corresponding points in the generic 3D model projected into 2D image space, and applying RBF deformation to the projected generic 3D model.

3. The method as claimed in claim 1, wherein step e) comprises calculating RBF parameters in 2D image space based on the feature points and corresponding points in the model for the synthesized 3D face projected into 2D image space, and applying RBF deformation to the projected model for the synthesized 3D face.

4. The method as claimed in claim 1, wherein step a) comprises applying a face detection algorithm to detect a face region in the single view image.

5. The method as claimed in claim 4, further comprising using an active shape model to extract the feature points from the detected face region.

6. A system for single view image 3D face synthesis comprising:
means for extracting feature points from the single view image;
means for transforming the feature points into 3D space;
means for calculating radial basis function (RBF) parameters in 3D space based on the transformed feature points and corresponding points from a 3D generic model;
means for applying RBF deformation to the generic 3D model based on the RBF parameters to determine a model for the synthesized 3D face; and
means for determining texture coordinates for the synthesized 3D face in 2D image space;
wherein the means for transforming the feature points symmetrically aligns the feature points, and
the means for determining the texture coordinates projects the generic 3D model or the model for the synthesized 3D face into 2D image space and applies RBF deformation to the projected generic 3D model or the projected model for the synthesized 3D face.

7. A data storage medium having computer code means for instructing a computer to execute a method of single view image 3D face synthesis comprising the steps of:
a) extracting feature points from the single view image;
b) transforming the feature points into 3D space;
c) calculating radial basis function (RBF) parameters in 3D space based on the transformed feature points and corresponding points from a 3D generic model;
d) applying RBF deformation to the generic 3D model based on the RBF parameters to determine a model for the synthesized 3D face; and
e) determining texture coordinates for the synthesized 3D face in 2D image space;
wherein step b) comprises symmetrically aligning the feature points, and
step e) comprises projecting the generic 3D model or the model for the synthesized 3D face into 2D image space and applying RBF deformation to the projected generic 3D model or the projected model for the synthesized 3D face.

8. A method of single view image 3D face synthesis comprising the steps of:
a) extracting feature points from the single view image;
b) transforming the feature points into 3D space;
c) calculating radial basis function (RBF) parameters in 3D space based on the transformed feature points and corresponding points from a 3D generic model;
d) applying RBF deformation to the generic 3D model based on the RBF parameters to determine a model for the synthesized 3D face; and
e) determining texture coordinates for the synthesized 3D face in 2 D image space;
wherein step b) comprises symmetrically aligning the feature points.

9. A method of single view image 3D face synthesis comprising the steps of:
a) extracting feature points from the single view image;
b) transforming the feature points into 3D space;
c) calculating radial basis function (RBF) parameters in 3D space based on the transformed feature points and corresponding points from a 3D generic model;
d) applying RBF deformation to the generic 3D model based on the RBF parameters to determine a model for the synthesized 3D face; and
e) determining texture coordinates for the synthesized 3D face in 2D image space;
wherein step e) comprises projecting the generic 3D model or the model for the synthesized 3D face into 2D image space and applying RBF deformation to the projected generic 3D model or the projected model for the synthesized 3D face.

10. A system for single view image 3D face synthesis comprising: for extracting feature points from the single view image;
means for transforming the feature points into 3D space;
means for calculating radial basis function (RBF) parameters in 3D space based on the transformed feature points and corresponding points from a 3D generic model;
means for applying RBF deformation to the generic 3D model based on the RBF parameters to determine a model for the synthesized 3D face; and
means for determining texture coordinates for the synthesized 3D face in 2D image space;
wherein the means for transforming the feature points symmetrically aligns the feature points.

11. A system for single view image 3D face synthesis comprising:
means for extracting feature points from the single view image;
means for transforming the feature points into 3D space;
means for calculating radial basis function (RBF) parameters in 3D space based on the transformed feature points and corresponding points from a 3D generic model;
means for applying RBF deformation to the generic 3D model based on the RBF parameters to determine a model for the synthesized 3D face; and
means for determining texture coordinates for the synthesized 3D face in 2D image space;
wherein the means for determining the texture coordinates projects the generic 3D model or the model for the synthesized 3D face into 2D image space and applies RBF deformation to the projected generic 3D model or the projected model for the synthesized 3D face.

12. A data storage medium having computer code means for instructing a computer to execute a method of single view image 3D face synthesis comprising the steps of:
a) extracting feature points from the single view image;
b) transforming the feature points into 3D space;
c) calculating radial basis function (RBF) parameters in 3D space based on the transformed feature points and corresponding points from a 3D generic model;
d) applying RBF deformation to the generic 3D model based on the RBF parameters to determine a model for the synthesized 3D face; and
e) determining texture coordinates for the synthesized 3D face in 2D image space;
wherein step b) comprises symmetrically aligning the feature points.

13. A data storage medium having computer code means for instructing a computer to execute a method of single view image 3D face synthesis comprising the steps of:
a) extracting feature points from the single view image;
b) transforming the feature points into 3D space;
c) calculating radial basis function (RBF) parameters in 3D space based on the transformed feature points and corresponding points from a 3D generic model;
d) applying RBF deformation to the generic 3D model based on the RBF parameters to determine a model for the synthesized 3D face; and
e) determining texture coordinates for the synthesized 3D face in 2D image space;
wherein step e) comprises projecting the generic 3D model or the model for the synthesized 3D face into 2D image space and applying RBF deformation to the projected generic 3D model or the projected model for the synthesized 3D face.
